(19) United States
(12) Patent Application Publication
(10) Pub. No.: US 2025/0313229 A1
(43) Pub. Date: Oct. 9, 2025

(54) METHOD FOR CONTROLLING AN AUTOMOTIVE MACHINE AUTONOMOUSLY

(71) Applicants: AMPERE S.A.S., BOULOGNE BILLANCOURT (FR); CENTRALESUPELEC, GIF-SUR-YVETTE (FR)

(72) Inventors: Joan DAVINS, GUYANCOURT CEDEX (FR); Emmanuel GODOY, GIF-SUR-YVETTE (FR); Pedro KVIESKA, GUYANCOURT CEDEX (FR); Dario PENCO, GUYANCOURT CEDEX (FR); Giorgio VALMORBIDA, GIF-SUR-YVETTE (FR)

(21) Appl. No.: 18/865,494

(22) PCT Filed: May 19, 2023
(86) PCT No.: PCT/EP2023/063519

§ 371 Date: Nov. 13, 2024

(30) Foreign Application Priority Data
May 18, 2022 (FR) 2204746

(51) Int. Cl. B60W 60/00; B60W 10/04; B60W 10/18; B60W 10/20

(52) U.S. Cl. CPC B60W 60/001; B60W 10/04; B60W 10/18; B60W 10/20; B60W 2520/06; B60W 2520/10; B60W 2520/105; B60W 2520/12; B60W 2520/14; B60W 2552/40; B60W 2710/18; B60W 2710/20; B60W 2720/106

(57) ABSTRACT

The invention relates to a method for autonomously controlling actuators of an automotive machine (10) which are adapted to influence the path and the speed of said automotive machine, including steps of:
acquiring a reference path that said automotive machine should follow,
determining a nominal value of at least one parameter enabling the automotive machine to follow the reference path,
determining a current value of each of said parameters when said automotive machine follows the reference path,
determining a value difference between the current value and the nominal value of each of said parameters, then
computing, with a computer, a control setpoint for each actuator, according to each value difference, by means of a corrector.

According to the invention, the corrector allows jointly computing an exclusively lateral control setpoint of the automotive machine and an exclusively longitudinal control setpoint of the automotive machine.

### TECHNICAL FIELD OF THE INVENTION

The present invention generally relates to the automation of path tracking of automotive machines.

It finds a particularly advantageous application in the context of motor vehicle driver assistances, but it could also be applied to the field of aeronautics or robotics.

More particularly, it relates to a method for autonomously controlling actuators of an automotive machine which are adapted to influence the path and the speed of said automotive machine, including steps of:
acquiring a reference path that said automotive machine should follow,
determining a nominal value of at least one parameter enabling the automotive machine to follow the reference path,
determining a current value of each parameter when said automotive machine follows the reference path,
determining a value deviation between the current value and the nominal value of each parameter, then
computing, with a computer, a control setpoint for each actuator, according to each value deviation, using for this purpose a mathematical object hereinafter so-called “corrector”.

It also relates to a machine equipped with a computer adapted to implement this method.

It also relates to a method for synthesising such a corrector.

This invention applies more particularly, yet not exclusively, to following an obstacle avoidance path by a motor vehicle.

### PRIOR ART

To safeguard motor vehicles, these are currently equipped with driver-assistance system or autonomous driving systems.

Among these systems, automatic emergency braking systems are known in particular (better known by the abbreviation AEB, standing for “Automatic Emergency Brakin” in English), designed to avoid any collision with obstacles located in the traffic lane taken by the vehicle, by simply acting on the conventional braking system of the motor vehicle.

Nonetheless, there are situations in which these emergency braking systems do not allow avoiding the collision or cannot be used (for example if a vehicle closely follows the motor vehicle).

For these situations, automatic avoidance systems have been developed (better known by the abbreviation AES, standing for “Advanced Evasive Steering” or “Automatic Emergency Steering” in English) which allow avoiding the obstacle by diverting the vehicle off its path, either by acting on the direction of the vehicle, or by acting on the differential braking system of the vehicle. It should be noted that the obstacle could be in the same lane as the vehicle or in an adjacent lane, in which case it is detected that this obstacle might be on the path of the vehicle within a short time.

Nonetheless, it happens that the AES system imposes on the vehicle a limit path in terms of controllability and which does not necessarily enable the driver to regain control of driving of the vehicle safely.

Indeed, the problem is that the so-called “high dynamic” avoidance manoeuvres, i.e. for which the acceleration experienced by the vehicle exceeds a threshold for example of 0.3 g, might generate instabilities and path tracking defects, such that they prove to be difficult to control.

### DISCLOSURE OF THE INVENTION

In order to overcome the aforementioned drawback of the prior art, the present invention provides a solution allowing coupling the lateral and longitudinal controls of the vehicle to ensure an accurate and stable control of the vehicle during high-dynamic manoeuvres, and in particular during obstacle avoidance manoeuvres.

More particularly, the invention provides a control method as defined in the introduction, wherein the corrector is used to jointly compute an exclusively lateral control setpoint of the automotive machine and an exclusively longitudinal control setpoint for the automotive machine.

In the case where the considered machine is a motor vehicle, the exclusively lateral control setpoint will be a steering setpoint for the steered wheels of the vehicle, and the exclusively longitudinal control setpoint will be a conventional braking setpoint for the wheels of the vehicle (therefore, we do not talk about a differential braking allowing braking and steering the vehicle at the same time).

Thus, the invention allows controlling the dynamics of the machine (in this case the vehicle) not only laterally with respect to the path that it should follow, but also longitudinally, by means of one single corrector.

In other words, when this method is implemented on a motor vehicle in order to avoid an obstacle, it is possible to control the steering and the braking (or the acceleration) of the vehicle via two actuators controlled jointly.

This solution allows guaranteeing better tracking of the obstacle avoidance path and a better stability to the vehicle.

Indeed, the corrector is capable of guaranteeing the stability and the performances of a modelling of the dynamics of the vehicle by a closed-loop system, for a very large set of reference paths at different speeds. Hence, thanks to the invention, it is not necessary to compute and develop a corrector for each path, once properly calibrated, the corrector being valid for a quite wide range of use.

In this respect, this corrector is pre-computed offline (during the design of the vehicle) and it is embedded afterwards on the vehicle, such that only simple computations have to be performed on the vehicle to find the desired control setpoints.

Thus, the invention is easy to implement.

Preferably, said automotive machine being a vehicle which comprises at least one wheel adapted to be steered in a variable direction, at least one power steering actuator, at least one braking actuator and at least one propulsion actuator of the vehicle, the lateral control setpoint is transmitted to said at least one power steering actuator to steer said at least one wheel, and the longitudinal control setpoint is transmitted to said at least one braking actuator and/or to said at least one propulsion actuator to brake or accelerate the vehicle.

The invention also relates to a method for developing a corrector for use thereof in a control method as mentioned before, wherein it is provided to:
model the automotive machine in a non-linear form,
linearise said model in a linear parameter-varying form,
synthesise a corrector which ensures a reference path tracking, and
   wherein the corrector is synthesised by considering a finite number of points defined by distinct values of variable parameters.

Other advantageous and non-limiting features of this method in accordance with the invention, considered individually or according to any technically-feasible combination, are as follows:
steps are provided for:
S1—acquiring a validation grid composed of several points,
S2—creating a first grid of points less dense than the validation grid,
S3—synthesising a first corrector with the first grid,
S4—determining whether the first corrector is valid over the entire validation grid, then:
if the first corrector is valid over the entire validation grid, the corrector is considered to be equal to the first corrector,
otherwise, another grid denser than the first grid is generated and then steps S3 and S4 are repeated with this other grid.
the first grid includes, for a most of the variable parameters, only the maximum and minimum limits of variation of these variable parameters, said limits being determined for two extreme reference paths.
the modelling of the automotive machine in a non-linear form is derived from equilibrium equations of the forces applied to the automotive machine.
the forces applied to the automotive machine comprising normal reaction forces as well as longitudinal and lateral friction forces that the ground exerts on wheels of the automotive machine, to linearise said model in a linear parameter-varying form, a thresholding function applied to the normal reaction forces and to the longitudinal and lateral friction forces is used.
the model considering control inputs of the actuators, to linearise said model in a linear parameter-varying form, a saturation function applied to the control inputs is used.
the variable parameters include the longitudinal acceleration of the automotive machine, its longitudinal speed, its lateral speed, its yaw rate, its heading angle and a steering angle.
the corrector includes an “anti-windup”.
the regulator is synthesised from convex optimisation criteria under linear matrix inequalities constraints, at least one of the constraints including:
minimising the performance in the direction H_{∞} of the relationship between a disturbance applied to the automotive machine and a position and/or yaw error of the automotive machine,
minimising the performance in the direction H_{2 generalised} of the relationship between a disturbance applied to the automotive machine and a control signal of the automotive machine,
taking account of the amplitude saturations of the actuators.

The invention also relates to an automotive machine comprising at least one actuator which is adapted to influence the path of said machine, at least one actuator which is adapted to influence the speed of said machine and a computer for controlling said actuators, programmed to implement a method as mentioned before.

Of course, the different features, variants and embodiments of the invention could be associated together according to various combinations to the extent that they are not incompatible or exclusive of each other.

### DETAILED DESCRIPTION OF THE INVENTION

The following description with reference to the appended drawings, given as non-limiting examples, will clearly explain what the invention consists of and how it could be carried out.

In the appended drawings:

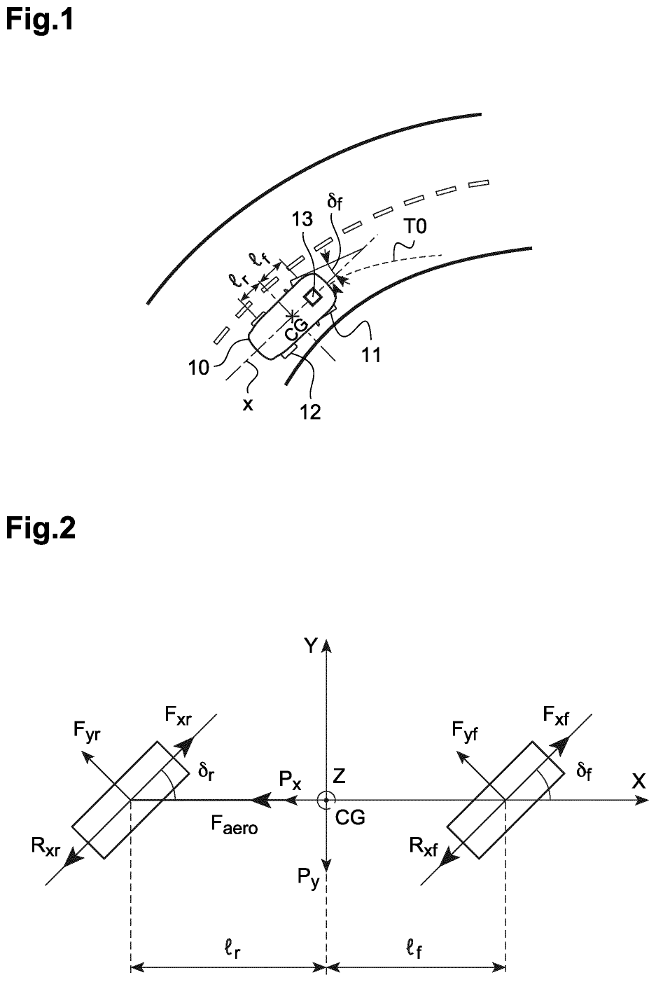

FIG. 1 is a schematic top view of a motor vehicle travelling on a road;

FIG. 2 is a representation of the bicycle model used to model the motor vehicle of FIG. 1;

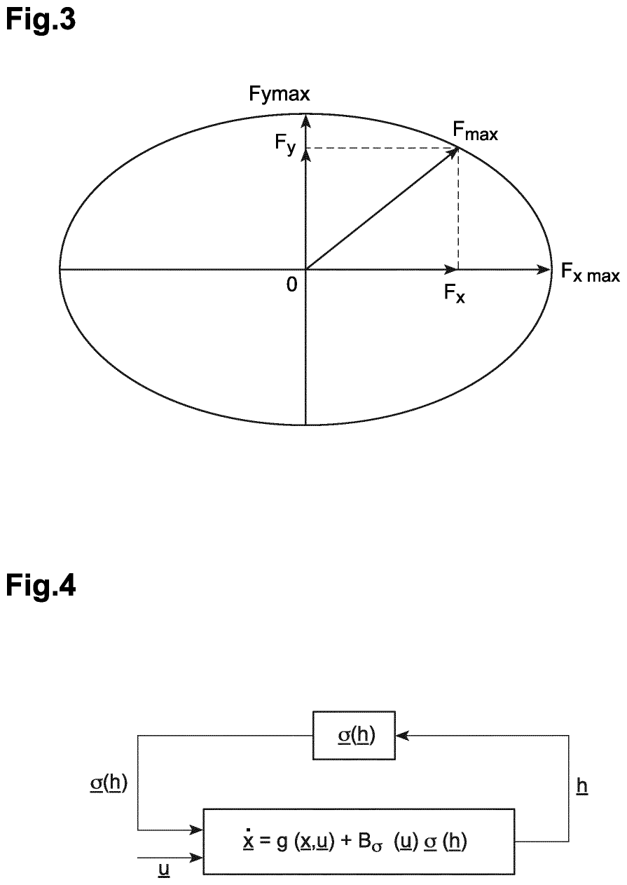

FIG. 3 is a graph illustrating the domain of variation of the longitudinal and lateral forces exerted on the tyres of the vehicle of FIG. 1;

FIG. 4 is a block diagram of a closed loop modelling the dynamics of the motor vehicle of FIG. 1;

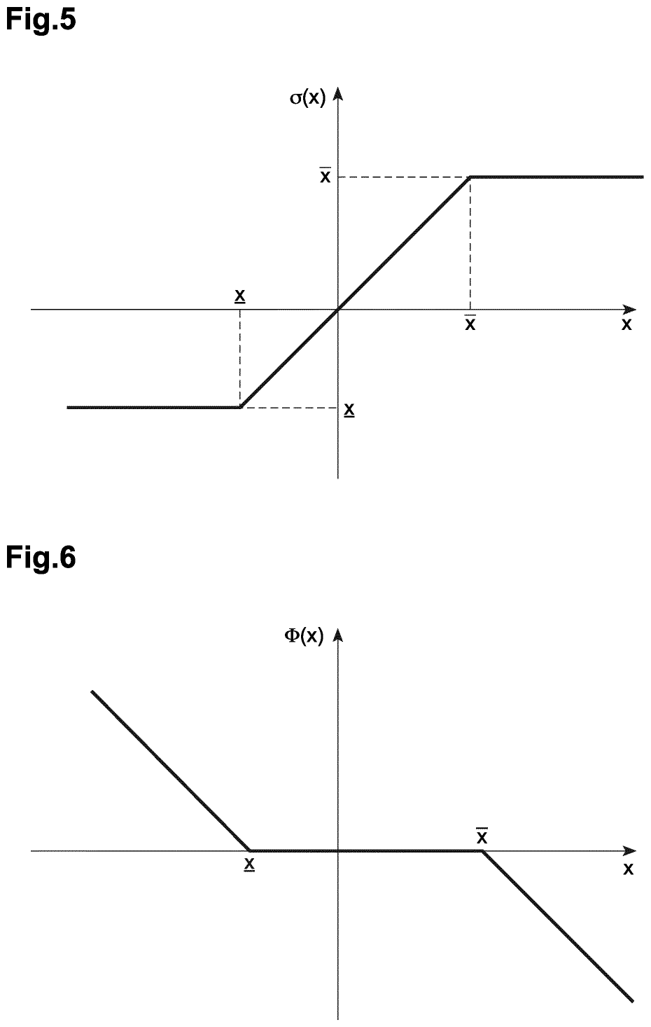

FIG. 5 is a graph illustrating the variations of a saturation function used in the context of the method in accordance with the invention;

FIG. 6 is a graph illustrating the variations of a threshold function used in the context of the method in accordance with the invention;

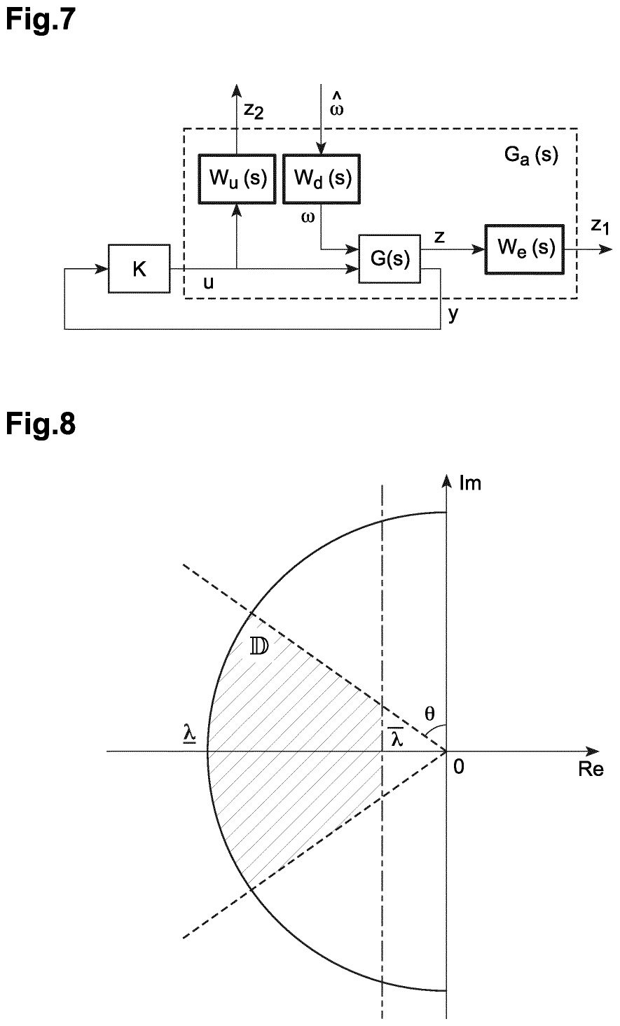

FIG. 7 is a block diagram of another closed loop modelling the dynamics of the motor vehicle of FIG. 1;

FIG. 8 is a graph illustrating a region in which the dynamics of the closed loop of FIG. 7 is bounded.

FIG. 1 shows a motor vehicle 10 conventionally comprising a chassis which delimits in particular a passenger compartment and an engine compartment, two steered front wheels 11, and two non-steered rear wheels 12. Alternatively, these two rear wheels could also be steered with an adaptation of the control law.

This motor vehicle 10 includes a conventional steering system allowing acting on the orientation of the steered wheels so as to be able to steer the vehicle. In particular, this conventional steering system comprises a steering wheel connected to tie rods in order to make the steered wheels pivot. In the considered example, it also includes at least one actuator allowing acting on the orientation of the steered wheels according to the orientation of the steering wheel and/or according to a request received from a computer 13. For this purpose, this power steering actuator may act on the steering column of the vehicle (which is fastened to the steering wheel) or on a rack (which connects the steering column to the steered wheels). Of course, the actuator could be positioned otherwise.

Moreover, the motor vehicle includes a conventional braking system allowing braking the four wheels so as to slow down the motor vehicle. In the considered example, this conventional braking system comprises at least one braking actuator. In this case, it includes several ones in order to be able to adjust, where necessary, the braking force exerted on each wheel.

Finally, the motor vehicle includes a powertrain, comprising in particular a propulsion actuator allowing controlling this powertrain in order to accelerate the motor vehicle 10.

The computer 13 is then designed to control the power steering actuator, the braking actuators and the actuator of the powertrain. To this end, it includes at least one processor, at least one memory and different input and output interfaces.

Thanks to its input interfaces, the computer 13 is adapted to receive input signals originating from different sensors.

Among these sensors, the following ones are for example provided:
a device such as a front camera, allowing locating the position of the vehicle with respect to its traffic lane,
a device such as a RADAR or LIDAR remote sensor, allowing detecting an obstacle located on the path of the motor vehicle 10,
at least one lateral device such as a RADAR or LIDAR remote sensor, allowing observing the environment on the sides of the vehicle,
a device such as a gyrometer, allowing determining the yaw rotational speed (about a vertical axis) of the motor vehicle 10, and
different sensors allowing estimating, for example, the longitudinal and lateral speed of the vehicle, the rotational speeds of the front and rear wheels of the vehicle, the steering angle of the front wheels, the cant angle and the slope of the road, etc.

Thanks to its output interfaces, the computer 13 is adapted to transmit a setpoint to the power steering actuator, to the actuator of the powertrain and to the braking actuators.

Thus, it allows forcing the vehicle to follow a reference path T0 that would have been defined beforehand. For example, this reference path T0 is an obstacle avoidance path.

Thanks to its memory, the computer 13 memorises data used in the context of the method described hereinbelow.

In particular, it memorises a computer application, consisting of computer programs comprising instructions, the execution of which by the processor enables the implementation of the method described hereinafter by the computer.

Before describing this method, the different variables that will be used, some of which are illustrated in FIGS. 1 and 2, may be entered.

The total weight of the motor vehicle will be denoted “m” and will be expressed in kg.

The centre of gravity of the vehicle will be denoted “CG”.

In this case, an orthogonal reference frame (CG, X, Y, Z) attached to the vehicle will be primarily considered. Its origin is coincident with the centre of gravity CG. The X axis corresponds to the longitudinal axis of the vehicle. The Y axis corresponds to the lateral axis directed towards the left of the vehicle. In practice, this Z axis is the axis normal to the road.

The vertical moment of inertia of the motor vehicle about the Z axis will be denoted “I_{zz}”, and will be expressed in N·m.

The distance between the centre of gravity CG and the front axle of the vehicle will be denoted “I_{f}” and will be expressed in metres. In general, the index f will be associated hereafter with the front wheels.

The distance between the centre of gravity CG and the rear axle will be denoted “Iᵣ” and will be expressed in metres. Next, the index r will be associated with the rear wheels.

The lateral moment of inertia of a wheel of the motor vehicle will be denoted “I_{wy}” and will be expressed in N·m.

The effective radius of a wheel will be denoted “rₑ” and will be expressed in metres.

The coefficient of friction between the ground and a tyre will be denoted μ.

The density coefficient of the air will be denoted ρ.

The aerodynamic drag coefficient of the vehicle will be denoted C_{d}.

The front surface of the vehicle will be denoted Af.

The lateral stiffness of the tyres of the front wheels will be denoted c_{αf}.

The lateral stiffness of the tyres of the rear wheels will be denoted c_{αr}.

The longitudinal stiffness of the tyres of the front wheels will be denoted c_{Kf}.

The longitudinal stiffness of the tyres of the rear wheels will be denoted c_{Kr}.

The coefficient of the rolling resistance forces of the front wheels will be denoted f_{rf}.

The coefficient of the rolling resistance forces of the rear wheels will be denoted fᵣᵣ.

The height of the centre of inertia CG of the vehicle above the ground will be denoted h.

The distribution ratio of the torque between the front and rear wheels will be denoted k_{τ}.

The longitudinal slip ratio of a tyre will be denoted κ.

The lateral slip angle of a tyre will be denoted α.

The acceleration of Earth gravity will be denoted g.

The steering angle that the front steered wheels form with the longitudinal axis X of the motor vehicle 10 will be denoted “δ_{f}” and will be expressed in rad.

The steering angle that the rear wheels form with the longitudinal axis X of the motor vehicle 10 will be denoted “δᵣ” and will be expressed in rad. It should herein be noted that, hereafter, this angle will be zero. Alternatively, it could be non-zero and be expressed as a function of the steering angle δ_{f}.

The torque at the front drive wheels will be denoted τ_{wf}.

The torque at the rear wheels will be denoted τ_{wr}. It should herein be noted that, hereafter, this torque will be expressed as a function of the torque at the front drive wheels. For example, it is possible to write: τ_{wr}=0.3. τ_{wf}

The cant angle of the road (i.e. its angle of inclination to the right or to the left) will be denoted θₓ and will be expressed in degrees, in the trigonometric direction.

The slope angle of the road will be denoted θ_{y} and will be expressed in degrees. It will be positive if the road climbs up and negative otherwise.

The yaw rate of the vehicle (about the axis Z) will be denoted “r” and will be expressed in rad/s.

The longitudinal speed of the vehicle, according to the X axis, will be denoted v and will be expressed in m/s.

The lateral speed of the vehicle, according to the Y axis, will be denoted u and will be expressed in m/s.

The rotational speed of the front wheels of the vehicle, around the axis of rotation of these wheels, will be denoted w, and will be expressed in rad/s.

The rotational speed of the rear wheels of the vehicle, around the axis of rotation of these wheels, will be denoted ω_{wr} and will be expressed in rad/s.

The relative heading angle between the X axis and the tangent to the reference path T0 will be denoted “Ψ” and will be expressed in rad.

Therefore, the yaw angle error between the heading of the vehicle and the tangent to the reference path T0 will be denoted Δψ.

The longitudinal position error between the vehicle and the reference path T0 will be denoted x_{L}.

The lateral position error between the vehicle and the reference path T0 will be denoted y_{L}.

These two errors could be expressed at the centre of gravity CG of the vehicle.

The method according to the invention is intended to enable the vehicle to follow the reference path T0 as accurately as possible, in an autonomous mode (without any intervention by the driver).

For example, this method is implemented when an AES automatic obstacle avoidance function has been triggered and then a reference path T0 has been computed. It should be noted that the manner in which the AES function is triggered and the reference path T0 is computed is not an object of the present invention, and will therefore not be described herein.

Given this path T0, it is possible to compute the nominal values of parameters enabling the motor vehicle 10 to follow exactly this path. Next, the objective will be to ensure that the vehicle follows exactly this path, i.e. that the deviations between the current values of these parameters and the nominal values along the reference path T0 are minimum.

The parameters allowing describing the path that the vehicle should follow are herein:
the longitudinal position of the vehicle (whose nominal value is denoted x₀ and the current value x),
the lateral position of the vehicle (whose nominal value is denoted y₀ and the current value y),
the heading angle of the vehicle (whose nominal value is denoted Ψ₀ and the current value Ψ),
the longitudinal speed v of the vehicle (whose nominal value is denoted v₀ and the current value v),
the lateral speed u of the vehicle (whose nominal value is denoted u₀ and the current value u),
the yaw rate r of the vehicle (whose nominal value is denoted r₀ and the current value r).

These parameters are determined in an absolute reference frame initialised at the beginning of the manoeuvre (which corresponds, in practice, to the reference frame attached to the vehicle at the time point at which the manoeuvre begins).

It is herein assumed that the computation of the nominal values is known.

At this stage, it could be noted that if the reference paths are provided by a path planner (DPL, standing for “Decision and Planning” in English), the latter can also compute the nominal setpoints δ_{f0} and τ_{wf0}.

If a path planner is not available, based on said reference paths T0, it is possible to compute the nominal commands from the following expressions:

$${δ}_{f 0} ( t ) = {ρ}_{0}^{′} ( t ) {v}_{0} ( t ) \frac{m}{2 {c}_{α f}} ( {v}_{0} ( t ) + \frac{2 {c}_{α f} {ℓ}_{f} - 2 {c}_{α r} {ℓ}_{r}}{m v} ) \qquad [ Math . 0 ]$$

$${τ}_{wf 0} ( t ) = \frac{\begin{matrix}m {\dot{v}}_{0} ( t ) + \frac{1}{2} {ρ}^{′} {C}_{d} {A}_{f} {v}^{2} + \frac{m g}{{ℓ}_{f} + {ℓ}_{r}} ( {f}_{rf} {ℓ}_{r} cos ( {δ}_{f} ) + {f}_{rr} {ℓ}_{f} ) + \\ \frac{{f}_{wy}}{{r}_{e}} ( {\dot{ω}}_{f 0} ( t ) cos ( {δ}_{f 0} ( t ) ) + {\dot{ω}}_{r 0} ( t ) )\end{matrix}}{\frac{{k}_{τ} + cos ( {δ}_{f 0} ( t ) )}{{r}_{e}}}$$

In this equation, the term ρ′ refers to the radius of curvature of the reference path T0.

Before describing the method that will be executed by the computer 13 to implement the invention itself, we could describe, in a first part of this description, the computations that have allowed reaching the invention, in order to clearly understand the origin of these computations and on which foundations they are based. In particular, we will explain how the corrector K that will allow computing control instructions of the vehicle according to measured data is synthesised.

Indeed, the idea of the first part of the disclosure is to describe the manner in which it is possible to synthesise a controller K which, once implemented in the computer 13, will allow controlling the vehicle so that it follows the reference path T0 in a stable and efficient manner.

In a first step, it will be possible to model the vehicle as well as the forces that act on the latter and of which we wish to take account in order to control the vehicle.

It will herein be considered that the dynamic behaviour of the vehicle can be modelled by means of a non-linear bicycle model.

In such a model, the two wheels of the front axle are considered to be coincident, and the same applies to the two rear wheels. In turn, the chassis of the vehicle is modelled by a body which connects the two wheel models.

Next, when talking about “front wheel”, in the singular, reference is made to this modelling of the two front wheels by one single wheel. Similarly, when talking about “rear wheel”, in the singular, reference is made to this modelling of the two rear wheels by one single wheel.

An orthogonal reference frame (O_{w}, x_{w}, y_{w}, z_{w}) attached to this wheel will then be considered for each wheel. Its origin is coincident with the geometric centre of this wheel. The axis y_{w} corresponds to the axis of rotation of the wheel. The axis x_{w} corresponds to the axis of the wheel orthogonal to the aforementioned axis and to the Z axis. Finally, the axis z_{w} is considered parallel to the Z axis.

At this stage, it could be noted that, when, in an equation or a reference, a term relates in a similar and obvious manner to the front wheel or to the rear wheel, it could be written without the index “f” or “r”. For example, for simplicity, we will talk about the orthogonal reference frame (O_{w}, x_{w}, y_{w}, z_{w}) associated with each wheel, while these reference frames could be written in a more laborious manner in the form (O_{wr}, x_{wr}, y_{wr}, z_{wr}) and (O_{wf}, x_{wf}, y_{wf}, z_{wf}).

The dynamic parameters of the vehicle that are taken into account, i.e. the parameters characterising its movements, are as follows:
the longitudinal translational movement of the body of the vehicle along the X axis,
the lateral translational movement of the body of the vehicle along the Y axis,
the yaw movement of the body of the vehicle about the Z axis,
the rolling movement of the front wheel about its axis of rotation Y_{wf}, and
the rolling movement of the rear wheel about its axis of rotation Y_{wr}.

In turn, the dynamic parameters of the vehicle neglected hereafter are as follows:
the vertical translational movement of the body of the vehicle along the Z axis, and
the roll and pitch movements of the body of the vehicle about the X and Y axes.

In view of the considered movements, the state variables of the vehicle system are:
the longitudinal speed v of the vehicle,
the lateral speed u of the vehicle,
the yaw rate r of the vehicle, and
the rotational speeds ω_{wf} and ω_{wr} of the front and rear wheels.

The state of the vehicle system could then be denoted: x=[v u r ω_{wf} ω_{wr}]^{τ}

The inputs of this vehicle system are:
the steering angle δ_{f} of the front wheel,
the torque τ_{wf} at the front wheel,
the cant angle θx of the road,
the slope angle θy of the road.

The input of the vehicle system will then be denoted: u=[δf τ_{wf} θx θy]^{τ}

Next, we will talk about control inputs when referring to the torque (δ_{f}, τ_{wf}) and about disturbance inputs when referring to the torque (θx, θy).

The forces that act on the vehicle system are shown in part in FIG. 2 and all of them are listed hereinafter:
the weight of the vehicle, with its three components (Pₓ, P_{y}, P_{z}) in the reference frame (CG, X, Y, Z),
the normal reaction forces oriented according to the Z axis (modelling bearing of the wheels against the ground) and denoted N_{f} for the front wheel and Nᵣ for the rear wheel,
the longitudinal friction forces of the tyres on the ground, denoted F_{xf} for the front wheel and Fₓᵣ for the rear wheel, expressed in the reference frame (O_{w}, x_{w}, y_{w}, z_{w}) attached to the corresponding wheel,
the lateral friction forces of the tyres on the ground, denoted F_{yf} for the front wheel and F_{yr} for the rear wheel, expressed in the reference frame (O_{w}, x_{w}, y_{w}, z_{w}) attached to the corresponding wheel,
the rolling resistance forces of the tyres, denoted R_{xf} for the front wheel and Rₓᵣ for the rear wheel, expressed in the reference frame (O_{w}, x_{w}, y_{w}, z_{w}) attached to the corresponding wheel and which form the friction forces of the wheels on their axes (they are applied at the centre of the wheel), and
the aerodynamic drag forces.

The axis of rotation of a wheel is not necessarily parallel to the Y axis. Each of the longitudinal and lateral friction forces of the tyres then has a longitudinal component and a lateral component in the reference frame (CG, X, Y, Z), such that it is possible to write:

$$\begin{matrix}{F}_{xxf} = {F}_{xf} cos {δ}_{f} & {F}_{xxr} = {F}_{xr} cos {δ}_{r} \\ {F}_{yxf} = {F}_{xf} sin {δ}_{f} & {F}_{yxr} = {F}_{xr} sin {δ}_{r} \\ {F}_{xyf} = {F}_{yf} sin {δ}_{f} & {F}_{xyr} = {F}_{yr} sin {δ}_{r} \\ {F}_{yyf} = {F}_{yf} cos {δ}_{f} & {F}_{yyr} = {F}_{yr} cos {δ}_{r} \\ {R}_{xxf} = {R}_{xf} cos {δ}_{f} & {R}_{xxr} = {R}_{xr} cos {δ}_{r} \\ {R}_{yxf} = {R}_{xf} sin {δ}_{f} & {R}_{yxr} = {R}_{xr} sin {δ}_{r}\end{matrix} \qquad [ Math . 1 ]$$

These equations may be simplified by considering the steering angle at the rear wheels being equal to zero, in particular in this case where only the front wheels of the vehicle are steered.

The vehicle system is considered in equilibrium such that the resultant and the resultant moment of the external forces are zero.

Hence, it is possible to write the following three equations:

$$m ( \dot{v} - r u ) = 2 {F}_{xxf} + 2 {F}_{xxr} - 2 {R}_{xxf} - 2 {R}_{xxr} - 2 {F}_{xyf} - 2 {F}_{xyr} - {P}_{x} - {F}_{aero} \qquad [ Math . 2 ]$$

$$m ( \dot{u} - r v ) = 2 {F}_{yxf} + 2 {F}_{yxr} - 2 {R}_{yxf} - 2 {R}_{yxr} - 2 {F}_{yyf} - 2 {F}_{yyr} - {P}_{y}$$

$${I}_{zz} \dot{r} = ( 2 {F}_{yxf} + 2 {F}_{yyf} - 2 {R}_{yxf} ) {ℓ}_{f} - ( 2 {F}_{yxr} + 2 {F}_{yyr} - 2 {R}_{yxr} ) {ℓ}_{r} .$$

The first equation is the resultant of the forces according to the X axis, the second one is the resultant of the forces according to the Y axis and the third one is the resultant of the moment about the Z axis.

It is also possible to write the equations of the rolling motion of the wheels:

$${I}_{wy} {\dot{ω}}_{wf} = {τ}_{wf} - 2 {F}_{xf} {r}_{e} \qquad [ Math . 3 ]$$

$${I}_{wy} {\dot{ω}}_{wr} = {τ}_{wr} - 2 {F}_{xr} {r}_{e}$$

It should be noted that the disturbance inputs (cant θₓ and slope θ_{y} angles of the road) will be used to compute the components Pₓ, P_{y}, P_{z} of the weight.

The longitudinal and lateral friction forces produced by the tyres of a wheel are respectively proportional to the longitudinal slip ratio κ and to the lateral slip angle α of the tyres. It is then possible to write:

$${\hat{F}}_{x} = {c}_{κ}^{*} ( μ , N , α ) κ \qquad [ Math . 4 ]$$

$${\hat{F}}_{y} = {c}_{α}^{*} ( μ , N , κ ) α .$$

In these equations, the circumflex “\hat{ }” indicates that it is the input of the saturation function.

The coefficients c_{κ}* and c_{α}* vary non-linearly according to the dynamics of the vehicle, in particular according to the longitudinal and lateral slips of the tyres, the normal reaction force N being exerted on the tyre and the coefficient of friction p between the tyre and the ground.

They are herein expressed in the form:

$${c}_{κ}^{*} ( μ , N , α ) = \frac{N {c}_{κ} μ ( 4 \sqrt{{c}_{α}^{2} {tan ( α )}^{2} + {c}_{κ}^{2} {κ}^{* 2}} + N μ ( {κ}^{*} - 1 ) )}{4 {c}_{α}^{2} {tan ( α )}^{2} + 4 {c}_{κ}^{2} {κ}^{* 2}} \qquad [ Math . 5 ]$$

$${c}_{α}^{*} ( μ , N , κ ) = \frac{N {c}_{α} μ ( 4 \sqrt{{α}^{* 2} {c}_{α}^{2} + {c}_{κ}^{2} {κ}^{2}} + N μ ( κ - 1 ) )}{4 {α}^{* 2} {c}_{α}^{2} + 4 {c}_{κ}^{2} {κ}^{2}} .$$

In these equations, it is possible to write the terms κ* and α* as follows:

$${κ}^{*} = \frac{N μ ( 4 {c}_{κ} + \sqrt{{N}^{2} {μ}^{2} + 8 {c}_{κ} N μ} + N μ}{8 {c}_{κ}^{2}} \qquad [ Math . 6 ]$$

$${α}^{*} = \frac{N μ}{2 {c}_{α}} .$$

The longitudinal slip ratio and the lateral slip angle for the two wheels are expressed in the form:

$${κ}_{f} = - \frac{v - {ω}_{f} {r}_{e}}{v} \qquad [ Math . 7 ]$$

$${κ}_{r} = - \frac{v - {ω}_{r} {r}_{e}}{v}$$

$$\text{And:}$$

$${α}_{f} = {δ}_{f} - \frac{u + {ℓ}_{f} r}{v} \qquad [ Math . 8 ]$$

$${α}_{r} = {δ}_{r} - \frac{u + {ℓ}_{r} r}{v}$$

The longitudinal and lateral friction forces produced by the tyres of a wheel, as expressed by the equations Math4, could grow indefinitely. However, it is observed that they actually saturate.

As shown in FIG. 3, this saturation can be modelled in the form of an ellipse, which shows that the total maximum force that the tyre is capable of withstanding follows the perimeter of an ellipse. Formulated otherwise, the longitudinal Fx and lateral Fy components of the forces always remain inside an ellipse and are at maximum equal to thresholds Fₓₘₐₓ and F_{ymax}.

In this case, to simplify the equations, it is considered that the ellipse is a circle, such that the two aforementioned thresholds are equal. These thresholds are proportional to the normal reaction force N, such that it is possible to write:

$${F}_{x} \leq \sqrt{{( μ N )}^{2} - {F}_{y}^{2}} \qquad [ Math . 9 ]$$

$${F}_{y} \leq \sqrt{{( μ N )}^{2} - {F}_{x}^{2}}$$

The normal reaction forces N that are exerted on the tyres are herein modelled by a variable load transfer model between the front wheel and the rear wheel, which depends on the dynamics of the vehicle (in particular its longitudinal acceleration, and possibly its lateral speed too). Indeed, it should be understood that the stresses that are exerted vertically on the front wheels are higher than those that are exerted on the rear wheels in case of braking. This is why this variable load transfer model between the front wheel and the rear wheel is considered.

For example, it is possible to write these forces in the following form:

$${N}_{f} = \frac{g m {ℓ}_{r}}{d ( {δ}_{f} , {δ}_{r} )} cos {θ}_{x} cos {θ}_{y} - \frac{g m h}{d ( {δ}_{f} , {δ}_{r} )} cos {θ}_{x} sin {θ}_{y} - \frac{m h}{d ( {δ}_{f} , {δ}_{r} )} ( \dot{v} - r u ) - \frac{h}{d ( {δ}_{f} , {δ}_{r} )} {F}_{aero} - \frac{2 {f}_{rr} g m {r}_{e}}{d ( {δ}_{f} , {δ}_{r} )} cos {δ}_{r} cos {θ}_{x} cos {θ}_{y} \qquad [ Math . 10 ]$$

$${N}_{r} = \frac{g m {ℓ}_{f}}{d ( {δ}_{f} , {δ}_{r} )} cos {θ}_{x} cos {θ}_{y} + \frac{g m h}{d ( {δ}_{f} , {δ}_{r} )} cos {θ}_{x} sin {θ}_{y} + \frac{m h}{d ( {δ}_{f} , {δ}_{r} )} ( \dot{v} - r u ) + \frac{h}{d ( {δ}_{f} , {δ}_{r} )} {F}_{aero} - \frac{2 {f}_{rf} g m {r}_{e}}{d ( {δ}_{f} , {δ}_{r} )} cos {δ}_{f} cos {θ}_{x} cos {θ}_{y}$$

In these equations, the function d is calculated as follows:

$$d ( {δ}_{f} , {δ}_{r} ) = {l}_{f} + {l}_{r} + 2 {f}_{rf} {r}_{e} cos {δ}_{f} - 2 {f}_{rr} {r}_{e} cos {δ}_{r} \qquad [ Math . 11 ]$$

These equations are herein obtained while considering that the vehicle system is in equilibrium such that the resultant of the external forces according to the Z axis and the resultant moments of the external forces about the X and Y axes are zero.

The rolling resistance force Rₓ of a wheel is considered to be proportional to the normal reaction force N, such that it is possible to write:

$${R}_{xf} = {f}_{rf} {N}_{f} \qquad [ Math . 12 ]$$

$${R}_{xr} = {f}_{rr} {N}_{r}$$

The aerodynamic drag force being primarily oriented according to the longitudinal axis X of the vehicle, its components according to the axes Y and Z are herein neglected. The remaining component, according to the X axis, is then expressed in the form:

$${F}_{aero} = \frac{1}{2} ρ {C}_{d} {A}_{f} {v}^{2} \qquad [ Math . 13 ]$$

At this stage, the considered vehicle model is therefore completely defined.

It is then now possible to explain how this model, which is non-linear by nature, could be linearised along the reference path T0.

For this purpose, a function f is introduced which depends on the state of the vehicle system, its derivative and its input. Considering the equations Math2 and Math3, it is then possible to write:

$$f ( \dot{\underline{x}} , \underline{x} , \underline{u} ) = 0 \qquad [ Math . 14 ]$$

$$f ( \dot{\underline{x}} , \underline{x} , \underline{u} ) = [ \begin{matrix}m \dot{v} - m r u - 2 {F}_{xxf} - 2 {F}_{xxr} + 2 {R}_{xxf} + 2 {R}_{xxr} + 2 {F}_{xyf} + {P}_{x} + {F}_{aero} \\ m \dot{u} + mrv - 2 {F}_{yxf} + 2 {R}_{yxf} - 2 {F}_{yyf} - 2 {F}_{yyr} + {P}_{y} \\ {I}_{zz} \dot{r} - ( 2 {F}_{yxf} + 2 {F}_{yyf} - 2 {R}_{yxf} ) {ℓ}_{f} + 2 {F}_{yyr} {ℓ}_{r} \\ {I}_{wy} {\dot{ω}}_{wf} - {τ}_{wf} + 2 {F}_{xf} {r}_{e} \\ {I}_{wy} {\dot{ω}}_{wr} - {k}_{τ} {τ}_{wf} + 2 {F}_{xr} {r}_{e}\end{matrix} ]$$

It should herein be noted that because of the non-linear dependency relationships between the longitudinal and lateral reaction forces F_{xf}, Fₓᵣ, F_{yf}, F_{yr} relative to the normal reaction forces N_{f}, Nᵣ, it is not possible to obtain an explicit form of the derivative of the state x (i.e. of the dynamics) of the vehicle system.

In the equation Math14, these forces are then isolated in order to write:

$$\dot{\underline{x}} = {\underbrace{[ \begin{matrix}r u - \frac{1}{m} {F}_{aero} - \frac{1}{m} {P}_{x} \\ - r v - \frac{1}{m} {P}_{y} \\ 0 \\ \frac{1}{{I}_{wy}} {τ}_{wf} \\ \frac{1}{{I}_{wy}} {k}_{τ} {τ}_{wf}\end{matrix} ]}}_{= y ( \underline{x} , \underline{u} )} + {\underbrace{[ \begin{matrix}\frac{1}{m} ( 2 {F}_{xxf} + 2 {F}_{xxr} - 2 {R}_{xxf} - 2 {R}_{xxr} - 2 {F}_{xyf} ) \\ \frac{1}{m} ( 2 {F}_{yxf} - 2 {R}_{yxf} + 2 {F}_{yyf} + 2 {F}_{yyr} ) \\ \frac{1}{{I}_{zz}} ( ( 2 {F}_{yxf} + 2 {F}_{yyf} - 2 {R}_{yxf} ) {ℓ}_{f} - 2 {F}_{yyr} {ℓ}_{r} ) \\ - \frac{2 {r}_{e}}{{I}_{wy}} {F}_{xf} \\ - \frac{2 {r}_{e}}{{I}_{wy}} {F}_{xr}\end{matrix} ]}}_{= M} . \qquad [ Math . 15 ]$$

Using the aforementioned equations and in particular the equation Math4, it is possible to develop the term M as follows:

$$M = [ \begin{matrix}\frac{1}{m} [ 2 σ ( {\hat{F}}_{xf} ( σ ( {\tilde{N}}_{f} ) ) ) cos {δ}_{f} + 2 σ ( {\hat{F}}_{xr} ( σ ( {\dot{N}}_{f} ) ) ) - 2 σ ( {F}_{yf} ( σ ( {\dot{N}}_{f} ) ) ) sin {δ}_{f} - σ ( {\dot{N}}_{f} ) {f}_{rf} cos {δ}_{f} - σ ( {\dot{N}}_{r} ) {f}_{rr} ] \\ \frac{1}{m} [ 2 σ ( {\hat{F}}_{yf} ( σ ( {\dot{N}}_{f} ) ) ) cos {δ}_{f} + 2 σ ( {\hat{F}}_{yr} ( σ ( {N}_{f} ) ) ) + 2 σ ( {\hat{F}}_{xf} ( σ ( {\dot{N}}_{f} ) ) ) sin {δ}_{f} - σ ( {\dot{N}}_{f} ) {f}_{rf} sin {δ}_{f} ] \\ \frac{1}{{I}_{zz}} [ 2 σ ( {\hat{F}}_{yf} ( σ ( {\dot{N}}_{f} ) ) ) {ℓ}_{f} cos {δ}_{f} - 2 σ ( {\hat{F}}_{yr} ( σ ( {\dot{N}}_{r} ) ) ) {ℓ}_{r} + 2 σ ( {\hat{F}}_{xf} ( σ ( {\hat{N}}_{f} ) ) ) {ℓ}_{f} sin {δ}_{f} - σ ( {\hat{N}}_{f} ) {f}_{rf} {ℓ}_{f} sin {δ}_{f} ] \\ - \frac{2 {r}_{e}}{{I}_{wy}} σ ( {\hat{F}}_{xf} ( σ ( {\dot{N}}_{f} ) ) ) \\ - \frac{2 {r}_{e}}{{I}_{wy}} σ ( {\hat{F}}_{xr} ( σ ( {\dot{N}}_{r} ) ) )\end{matrix} ] \qquad [ Math . 16 ]$$

In this equation, to take account of the saturation of the friction forces of the tyres (according to the ellipse of FIG. 3), a vector of saturation functions a has been introduced, which could be written in the following form:

$$\underline{σ} ( \underline{h} ) = [ \begin{matrix}σ ( {h}_{1} ( \dot{\underline{x}} , \underline{x} , \underline{u} ) ) \\ σ ( {h}_{2} ( \dot{\underline{x}} , \underline{x} , \underline{u} ) ) \\ σ ( {h}_{3} ( \dot{\underline{x}} , \underline{x} , \underline{u} , \underline{σ} ) ) \\ σ ( {h}_{4} ( \dot{\underline{x}} , \underline{x} , \underline{u} , \underline{σ} ) ) \\ σ ( {h}_{5} ( \dot{\underline{x}} , \underline{x} , \underline{u} , \underline{σ} ) ) \\ σ ( {h}_{6} ( \dot{\underline{x}} , \underline{x} , \underline{u} , \underline{σ} ) )\end{matrix} ] \qquad [ Math . 17 ]$$

In this equation, the input h before saturation has been introduced, whose vector could be written:

$$\underline{h} ( \dot{\underline{x}} , \underline{x} , \underline{u} , \underline{σ} ) = [ \begin{matrix}{h}_{1} ( \dot{\underline{x}} , \underline{x} , \underline{u} ) \\ {h}_{2} ( \dot{\underline{x}} , \underline{x} , \underline{u} ) \\ {h}_{3} ( \dot{\underline{x}} , \underline{x} , \underline{u} , \underline{σ} ) \\ {h}_{4} ( \dot{\underline{x}} , \underline{x} , \underline{u} , \underline{σ} ) \\ {h}_{5} ( \dot{\underline{x}} , \underline{x} , \underline{u} , \underline{σ} ) \\ {h}_{6} ( \dot{\underline{x}} , \underline{x} , \underline{u} , \underline{σ} )\end{matrix} ] = [ \begin{matrix}{\hat{N}}_{f} \\ {\hat{N}}_{r} \\ {\hat{F}}_{xf} ( σ ( {\hat{N}}_{f} ) ) \\ {\hat{F}}_{xr} ( σ ( {\hat{N}}_{r} ) ) \\ {\hat{F}}_{yf} ( σ ( {\hat{N}}_{f} ) ) \\ {\hat{F}}_{yr} ( σ ( {\hat{N}}_{r} ) )\end{matrix} ] \qquad [ Math . 18 ]$$

Thus, the term M could be reformulated as follows:

$$M = {\underbrace{[ \begin{matrix}- \frac{1}{m} {f}_{rf} cos {δ}_{f} & - \frac{1}{m} {f}_{rr} & \frac{2}{m} cos {δ}_{f} & \frac{2}{m} & - \frac{2}{m} sin {δ}_{f} & 0 \\ - \frac{1}{m} {f}_{rf} sin {δ}_{f} & 0 & \frac{2}{m} sin {δ}_{f} & 0 & \frac{2}{m} cos {δ}_{f} & \frac{2}{m} \\ - \frac{1}{{I}_{zz}} {ℓ}_{f} {f}_{rf} sin {δ}_{f} & 0 & \frac{2}{{I}_{zz}} {ℓ}_{f} sin {δ}_{f} & 0 & \frac{2}{{I}_{zz}} {ℓ}_{f} cos {δ}_{f} & - \frac{2}{{I}_{zz}} {ℓ}_{r} cos {δ}_{r} \\ 0 & 0 & - \frac{2 {r}_{y}}{{I}_{xy}} & 0 & 0 & 0 \\ 0 & 0 & 0 & - \frac{2 {r}_{e}}{{I}_{xy}} & 0 & 0\end{matrix} ]}}_{= {B}_{h} ( \underline{u} )} \underline{σ} ( \underline{h} ) \qquad [ Math . 19 ]$$

Consequently, the equations Math15 and Math19 allows writing our modelling of the vehicle system in the form:

$$\dot{\underline{x}} = g ( \underline{x} , \underline{u} ) + {B}_{h} ( \underline{u} ) \underline{σ} ( \underline{h} ) \qquad [ Math . 20 ]$$

FIG. 4 then shows the closed loop expressed by this equation in the form of a block diagram. It is observed that the normal reaction forces at the wheels and the longitudinal and lateral friction forces of tyres of the wheels, represented by the vector σ(h), are looped on this model of the dynamics of the state of the vehicle system, since they appear at the input of this system and they depend solely on the vector h at the output of this system. Thus, it will be possible to describe this situation in the form of a simple equation (Math23 hereinafter).

The linearisation of the model expressed by the equation Math20 along the reference path T0 could then be written as follows:

$$Δ \dot{\underline{x}} = \hat{A} ( t ) Δ \underline{x} + \hat{B} ( t ) Δ \underline{u} + {\hat{B}}_{h} ( t ) \underline{σ} ( Δ \underline{h} ) \qquad [ Math . 21 ]$$

$$Δ \underline{h} = {\hat{C}}_{h} ( t ) Δ \underline{x} + {\hat{D}}_{hu} ( t ) Δ \underline{u} + {\hat{D}}_{hh} ( t ) \underline{σ} ( Δ \underline{h} )$$

$$\hat{A} ( t ) = \frac{\partial g ( \underline{x} , \underline{u} )}{\partial \underline{x}} {\vert}_{( {\underline{x}}_{0} ( t ) , {\underline{u}}_{0} ( t ) )}$$

$$\hat{B} ( t ) = \frac{\partial g ( \underline{x} , \underline{u} )}{\partial \underline{u}} {\vert}_{( {\underline{x}}_{0} ( t ) , {\underline{u}}_{0} ( t ) )} + \frac{\partial ( {B}_{h} ( \underline{u} ) \underline{σ} ( \underline{h} ) )}{\partial \underline{u}} {\vert}_{( {\underline{u}}_{0} ( t ) , {\underline{σ}}_{0} ( t ) )}$$

$${\hat{B}}_{h} ( t ) = {B}_{h} ( \underline{u} ) {\vert}_{{\underline{u}}_{0} ( t )}$$

$${\hat{C}}_{h} ( t ) = \frac{\partial h ( \dot{\underline{x}} , \underline{x} , \underline{u} , \underline{σ} )}{\partial \dot{\underline{x}}} {\vert}_{( {\dot{\underline{x}}}_{0} ( t ) , {\underline{x}}_{0} ( t ) , {\underline{u}}_{0} ( t ) , {\underline{σ}}_{0} ( t ) )} \hat{A} ( t ) + \frac{\partial h ( \dot{\underline{x}} , \underline{x} , \underline{u} , \underline{σ} )}{\partial \underline{x}} {\vert}_{( {\dot{\underline{x}}}_{0} ( t ) , {\underline{x}}_{0} ( t ) , {\underline{u}}_{0} ( t ) , {\underline{σ}}_{0} ( t ) )}$$

$${\hat{D}}_{hu} ( t ) = \frac{\partial h ( \dot{\underline{x}} , \underline{x} , \underline{u} , \underline{σ} )}{\partial \dot{\underline{x}}} {\vert}_{( {\dot{\underline{x}}}_{0} ( t ) , {\underline{x}}_{0} ( t ) , {\underline{u}}_{0} ( t ) , {\underline{σ}}_{0} ( t ) )} \hat{B} ( t ) + \frac{\partial h ( \dot{\underline{x}} , \underline{x} , \underline{u} , \underline{σ} )}{\partial \underline{u}} {\vert}_{( {\dot{\underline{x}}}_{0} ( t ) , {\underline{x}}_{0} ( t ) , {\underline{u}}_{0} ( t ) , {\underline{σ}}_{0} ( t ) )}$$

$${\hat{D}}_{hh} ( t ) = \frac{\partial h ( \dot{\underline{x}} , \underline{x} , \underline{u} , \underline{σ} )}{\partial \dot{\underline{x}}} {\vert}_{( {\dot{\underline{x}}}_{0} ( t ) , {\underline{x}}_{0} ( t ) , {\underline{u}}_{0} ( t ) , {\underline{σ}}_{0} ( t ) )} {\hat{B}}_{h} ( t ) + \frac{\partial h ( \dot{\underline{x}} , \underline{x} , \underline{u} , \underline{σ} )}{\partial \underline{σ}} {\vert}_{( {\dot{\underline{x}}}_{0} ( t ) , {\underline{x}}_{0} ( t ) , {\underline{u}}_{0} ( t ) , {\underline{σ}}_{0} ( t ) )}$$

In these equations, the index “0” refers to the aforementioned nominal values. The vertical bar refers to the Jacobian at a given point.

It should be noted that the second equation (Δh) is formed on the basis of the same method as the first equation.

A continuous function, yet with a discontinuous derivative, is used as a saturation function. It herein consists of a function whose derivative is continuous, except at two distinct points. It has a constant value on either side of these two points, and a value that varies increasingly in an affine manner between these two points.

Hence, this function, illustrated in FIG. 5, could be defined by:

$$σ ( x ) = \{ \begin{matrix}\overline{x} , & x \geq \overline{x} \\ x , & \underline{x} \leq x \leq \overline{x} \\ \underline{x} , & x \leq \underline{x}\end{matrix} \qquad [ Math . 22 ]$$

Referring to FIG. 6, a continuous threshold function, yet with a discontinuous derivative, is also introduced. It herein consists of a function whose derivative is continuous, except at two distinct points. It has a constant value between these two points, and a value that varies decreasingly in an affine manner on either side of these two points.

Hence, this threshold function could be defined by:

$$ϕ ( x ) = σ ( x ) - x \qquad [ Math . 23 ]$$

The model is herein linearised on the basis of this threshold function since, as it will become apparent upon reading the remainder of this description, there is a condition which is useful for the synthesis of the corrector K for this function. To sum up, the use of this threshold function actually allows guaranteeing the stability of the closed loop in an area, while maximising the size of this area.

It is then possible to express the model given by the second equation Math21 as a function of this expression, by performing the following operations:

$$Δ \underline{h} = {\hat{C}}_{h} ( t ) Δ \underline{x} + {\dot{D}}_{hu} ( t ) Δ \underline{u} + {\hat{D}}_{hh} ( t ) \underline{σ} ( Δ \underline{h} ) - {\hat{D}}_{hh} ( t ) Δ \underline{h} + {\hat{D}}_{hh} ( t ) Δ \underline{h} \qquad [ Math . 24 ]$$

$$( I - {\dot{D}}_{hh} ( t ) ) Δ \underline{h} = {\dot{C}}_{h} ( t ) Δ \underline{x} + {\dot{D}}_{hu} ( t ) Δ \underline{u} + {\hat{D}}_{hh} ( t ) \underline{σ} ( Δ \underline{h} )$$

$$Δ \underline{h} = {\underbrace{{( I - {\hat{D}}_{hh} ( t ) )}^{- 1} {\dot{C}}_{h} ( t )}}_{= {\tilde{C}}_{h} ( t )} Δ \underline{x} + {\underbrace{{( I - {\hat{D}}_{hh} ( t ) )}^{- 1} {\dot{D}}_{hu} ( t )}}_{= {\tilde{D}}_{h u} ( t )} Δ \underline{u} + {\underbrace{{( I - {\hat{D}}_{hh} ( t ) )}^{- 1} {\dot{D}}_{hh} ( t )}}_{= {\tilde{D}}_{hh} ( t )} \underline{ϕ} ( Δ \underline{h} )$$

Similarly, it is possible to describe the dynamics of the state of the vehicle system in the following successive forms:

$$Δ \dot{\underline{x}} = \hat{A} ( t ) Δ \underline{x} + \hat{B} ( t ) Δ \underline{u} + {\hat{B}}_{h} ( t ) \underline{σ} ( Δ \underline{h} ) - {\hat{B}}_{h} ( t ) Δ \underline{h} + {\dot{B}}_{h} ( t ) Δ \underline{h} \qquad [ Math . 25 ]$$

$$Δ \dot{\underline{x}} = \hat{A} ( t ) Δ \underline{x} + {\hat{B}}_{h} ( t ) \underline{ϕ} ( Δ \underline{h} ) - \hat{B} ( t ) Δ \underline{u} + {\dot{B}}_{h} ( t ) \tilde{C} ( t ) Δ \underline{x} + {\hat{B}}_{h} ( t ) \tilde{D} ( t ) Δ u + {\dot{B}}_{h} ( t ) \tilde{D} ( t ) \underline{ϕ} ( Δ \underline{h} )$$

$$Δ \dot{\underline{x}} = {\underbrace{( \hat{A} ( t ) + {\hat{B}}_{h} ( t ) \tilde{C} ( t ) )}}_{= \overline{A} ( t )} Δ \underline{x} + {\underbrace{( \dot{B} ( t ) + {\hat{B}}_{h} ( t ) \tilde{D} ( t ) )}}_{= \overline{B} ( t )} Δ \underline{u} + {\underbrace{( {\dot{B}}_{h} ( t ) + {\hat{B}}_{h} ( t ) \tilde{D} ( t ) )}}_{= {\overline{B}}_{h} ( t )} \underline{ϕ} ( Δ \underline{h} ) .$$

It is then possible to apply the saturation function to the two expressions Math24 and Math25, which allows writing:

$$\tilde{A} ( t ) = \hat{A} ( t ) + {\hat{B}}_{h} ( t ) \tilde{C} ( t ) \qquad [ Math . 26 ]$$

$$\tilde{B} ( t ) = \hat{B} ( t ) + {\hat{B}}_{h} ( t ) \tilde{D} ( t )$$

$${\tilde{B}}_{h} ( t ) = {\hat{B}}_{h} ( t ) + {\hat{B}}_{h} ( t ) {\tilde{D}}_{hh} ( t )$$

$${\tilde{C}}_{h} ( t ) = {( I - {\hat{D}}_{hh} ( t ) )}^{- 1} {\hat{C}}_{h} ( t )$$

$${\tilde{D}}_{hu} ( t ) = {( I - {\hat{D}}_{hh} ( t ) )}^{- 1} {\hat{D}}_{hu} ( t )$$

$${\tilde{D}}_{hh} ( t ) = {( I - {\hat{D}}_{hh} ( t ) )}^{- 1} {\hat{D}}_{hh} ( t ) .$$

The dynamics of the linearised model given by the equations Math24 are herein added to the dynamics of the errors of the longitudinal x_{L} and lateral y_{L} absolute position and of the yaw angle Δψ of the vehicle system:

$${\dot{x}}_{L} = Δ v \qquad [ Math . 27 ]$$

$${\dot{y}}_{L} = Δ v {ψ}_{0} + Δψ {v}_{0}$$

$$Δ \dot{ψ} = Δ r$$

Thus, the equations Math26 allow taking account of the dynamic characteristics of the vehicle, whereas the equations Math27 allow imposing a good path tracking on the vehicle. This combination of equations then allows ensuring a good control of the vehicle along the reference path T0.

At this stage, the model being linearised and broadened to the equations Math26 and Math27, it is desired to transform it into a grid-based LPV model (better known by the English name “LPV grid-based”).

An LPV model allows representing a system in a linear form with varying parameters.

In our LPV model, the variation space of these parameters is bounded by maximum and minimum thresholds.

The idea of a “grid-based” model then consists in synthesising a corrector K while considering a very limited number of points of this space, and then attempting to validate it by verifying that this corrector K is valid for a larger number of points of this space, and finally using this corrector K if the solution is validated, or starting again by synthesising the corrector K with a larger number of points.

To model this system in this way, two distinct vectors are considered, namely a first vector Δu for the control inputs and a second vector Δw for the disturbance inputs. Hence, our linearised model is expressed by:

$$Δ \dot{\underline{x}} = A ( t ) Δ \underline{x} + {B}_{w} ( t ) Δ \underline{w} + {B}_{u} ( t ) Δ \underline{u} + {\tilde{B}}_{h} ( t ) \underline{ϕ} ( Δ \underline{h} ) \qquad [ Math . 28 ]$$

$$Δ \underline{h} = {C}_{h} ( t ) Δ \underline{x} + {D}_{hw} ( t ) Δ \underline{w} + {D}_{hu} ( t ) Δ \underline{u} + {D}_{hh} ( t ) \underline{ϕ} ( Δ \underline{h} )$$

$$avec A ( t ) ∈ {ℝ}^{n \times n} , {B}_{w} ( t ) ∈ {ℝ}^{n \times {m}_{w}} , {B}_{u} ( t ) ∈ {ℝ}^{n \times {m}_{u}} , {B}_{h} ( t ) ∈ {ℝ}^{n \times {p}_{h}} , {C}_{h} ( t ) ∈ {ℝ}^{{p}_{h} \times n} , {D}_{hw} ( t ) ∈ {ℝ}^{{p}_{h} \times {m}_{w}} , {D}_{hu} ( t ) ∈ {ℝ}^{{p}_{h} \times {m}_{u}} , {D}_{hh} ( t ) ∈ {ℝ}^{{p}_{h} \times {p}_{h}} et :$$

$$Δ \underline{x} = [ \begin{matrix}Δ v \\ Δ u \\ Δ r \\ {x}_{L} \\ {y}_{L} \\ Δ ψ \\ {Δω}_{wf} \\ {Δω}_{wr}\end{matrix} ]$$

$$Δ \underline{w} = [ \begin{matrix}{Δθ}_{x} \\ {Δθ}_{y}\end{matrix} ]$$

$$Δ \underline{u} = [ \begin{matrix}{Δδ}_{f} \\ {Δτ}_{wf}\end{matrix} ]$$

It should herein be noted that the order of the system n (namely the dimension of the square matrix A(t)) is equal to 8, that the number of disturbance inputs m_{w} is equal to 2, that the number of measurement inputs mᵤ is equal to 2, that the number of parameters of the vector h is denoted pₕ and is herein equal to 6.

The matrices of the model given by the first expression of the equation Math28 depend on the state variables and the inputs of the system, and more particularly on:
the longitudinal acceleration dv/dt of the vehicle,
its longitudinal speed v,
its lateral speed u,
its yaw rate r,
its yaw angle ψ,
its wheel rotational speeds ω_{wf} and ω_{wr}, and
its steering angle δ_{f}.

These eight variables could be used as variable parameters of the grid-based LPV model.

Nonetheless, the number of points of the grid increases exponentially with the number of time-variable parameters, which considerably overburdens the computations. Hence, we have chosen to reduce this number of variable parameters to limit the points of the grid and simplify the synthesis of the corrector K.

For this purpose, the rotational speeds of the wheels are computed according to the longitudinal speed v of the vehicle, assuming that no wheel slip is present. It is then possible to write:

$${ω}_{wf} = {ω}_{wr} = \frac{v}{{r}_{e}} \qquad [ Math . 29 ]$$

For the synthesis of the correctors, two distinct reference paths T0 have been considered arbitrarily, namely:
a path T0₁ associated with a change over two lanes without braking (the vehicle passes from its traffic lane to the immediately adjacent traffic lane and then to the next traffic lane, without braking, at 70 km/h), and
a path T0₂ associated with a change over one single lane with braking (the vehicle passes from its traffic lane to the immediately adjacent traffic lane while decelerating from 85 km/h to 35 km/h).

These two paths symbolise two types of extreme manoeuvring for which it is desired to stabilise the vehicle.

The objective is then to develop one single corrector K which is capable of controlling the vehicle according to these two “extreme” reference paths, and, therefore, according to all the reference paths comprised between these two paths.

In these two extreme conditions, the approximation of the equation Math29 is reasonable (in particular in case of avoidance with braking) because the slip is low (which could be controlled during tests or in simulation). Consequently, it is possible to reduce the number of variable parameters to six. These variable parameters pᵢ together form the vector p, which could be written in the form: p=[\dot{v}, v, u, r, ψ, δ_{f}]^{τ}

These tests have then allowed raising the maximum and minimum values taken by these variable parameters.

Hence, we have herein chosen to bound the variation intervals of the state variables and of the inputs of the vehicle system along the two reference paths in order to define the maximum and minimum thresholds of the variable parameters pᵢ. These thresholds are disclosed in the tables hereinbelow, successively for the two reference paths T0₁ and T0₂.

Thus, the thresholds for the reference pain T0₁ (without braking) are:

TABLE 1

| | | |
|---|---|---|
| Parameter | pᵢ | p̅ᵢ |

| | | | | |
|---|---|---|---|---|
| \dot{ν} | −0.2557 | m/s² | 0 | m/s² |
| v | 19.075 | m/s | 19.482 | m/s |
| u | −0.2761 | m/s | 0.2840 | m/s |
| r | −0.2887 | rad/s | 0.2448 | rad/s |
| ψ | 0 | rad | 0.2618 | rad |
| δ_{f} | −0.0469 | rad | 0.0381 | rad |

The thresholds tor the reference path T0₂ (with braking) are:

TABLE 2

| | | |
|---|---|---|
| Parameter | pᵢ | p̅ᵢ |

| | | | | |
|---|---|---|---|---|
| \dot{ν} | −5.2251 | m/s² | 0 | m/s² |
| v | 9.5808 | m/s | 19.482 | m/s |
| u | −0.2596 | m/s | 0.0350 | m/s |
| r | −0.1520 | rad/s | 0.1766 | rad/s |
| ψ | 0 | rad | 0.1450 | rad |
| δ_{f} | −0.0305 | rad | 0.0285 | rad |

A corrector K capable of controlling the vehicle along the two reference paths is looked for.

Consequently, the most extreme values among the limits associated with the two manoeuvres are used for the definition of the grid-based LPV model.

A notable exception is made for the yaw angle ψ. Indeed, the upper bound in terms of absolute value is considered and it is used to establish a variation interval symmetrical with respect to zero. Indeed, to establish the two tables hereinabove, the vehicle has moved to the left, such that the minimum yaw angle threshold is 0 degrees. Yet, it is desired to be able to perform manoeuvres to the right, with a negative yaw angle.

To sum up, for all reference paths T0 (with or without braking), the following limits will be used:

TABLE 3

| | | |
|---|---|---|
| Parameter | pᵢ | p̅ᵢ |

| | | | | |
|---|---|---|---|---|
| \dot{ν} | −5.2251 | m/s² | 0 | m/s² |
| v | 9.5808 | m/s | 23.261 | m/s |
| u | −0.2761 | m/s | 0.2840 | m/s |
| r | −0.2887 | rad/s | 0.2448 | rad/s |
| ψ | −0.2618 | rad | 0.2618 | rad |
| δ_{f} | −0.0469 | rad | 0.0381 | rad |

It should be noted that these values are given as an illustrative example, for a given vehicle model (that one on which the tests have been carried out).

Hence, the LPV model is expressed by the following equations:

$$Δ \dot{\underline{x}} = A ( \underline{p} ) Δ \underline{x} + {B}_{w} ( \underline{p} ) Δ \underline{w} + {B}_{u} ( \underline{p} ) Δ \underline{u} + {B}_{h} ( \underline{p} ) \underline{ϕ} ( Δ \underline{h} ) \qquad [ Math . 30 ]$$

$$Δ \underline{h} = {C}_{h} ( \underline{p} ) Δ \underline{x} + {D}_{hw} ( \underline{p} ) Δ \underline{w} + {D}_{hu} ( \underline{p} ) Δ \underline{u} + {D}_{hh} ( \underline{p} ) \underline{ϕ} ( Δ \underline{h} )$$

With the grid-based LPV approach, the LTI (linear time-invariant) linear) models suggest fixing the values of the variable parameters pᵢ over a set of points of the variation domain of the vector p in order to define a grid.

For the synthesis of the corrector K with the grid-based LPV approach, two different grids are used, namely:
a synthesis grid (to synthesise the corrector K as simply as possible), and
a validation grid denser than the synthesis grid (to verify whether the corrector K thus synthesised is actually valid over the entire domain).

The way of proceeding is then as follows:
we create the least dense possible synthesis grid,
we carry out the synthesis of the corrector K with the synthesis grid,
we determine whether the synthesised corrector K functions over the entire validation grid, then:
   if the solution is validated on the validation grid, the corrector K is adopted,
   otherwise, a new synthesis grid denser than the previous one is generated and then the procedure is started again.

We have chosen to start the process using a synthesis grid that is as dense as possible but which is located along the boundaries of the variation space of the vector p. This first synthesis grid is then formed herein solely by the vertices of the hypercube containing the variation domain of this vector p.

Nonetheless, it has been observed that it was not possible to synthesise a valid corrector while considering this first synthesis grid with 2⁶ points.

Consequently, in accordance with the process set out hereinabove, a denser second synthesis grid with 2⁷ points (i.e. 128 points) has been considered.

The values considered for each variable parameter pᵢ of this first synthesis grid are as follows:

TABLE 4

| Parameter | Value |
|---|---|
| \dot{ν} | [−5.2251; 0] |
| v | [9.5808; 14.1409; 18.7011; 23.261] |
| u | [−0.2761; 0.2840] |
| r | [−0.2887; 0.2448] |
| ψ | [−0.2618; 0.2618] |
| δ_{f} | [−0.0469; 0.0381] |

One could notice that, for all of the parameters, except or the longitudinal speed v, only the extreme values of the variation domain have been considered (i.e. their vertices of the hypercube). As regards the longitudinal speed v, it has been observed that a larger number of values was necessary for the found solution to be verified with the validation grid.

In other words, all of the possible combinations of these values have been considered to synthesise the corrector K.

As regards the validation grid, we have chosen to use twelve values per variable parameter, evenly distributed over its variation domain. In this case, all of the possible combinations of the values of the parameters form the points of the grid, which therefore contains about three million points (12⁶).

It should be understood that synthesising the corrector K while considering only this validation grid would have required an excessive computing power to rapidly reach a solution. This is the reason why it has been chosen to operate with two grids, according to the process set out hereinabove.

We could now explain how the dynamic corrector K is synthesised.

The synthesis of the dynamic LPV corrector given by the equation Math30 takes account of the saturations of the forces of the tyre, thanks to the threshold function. It is also herein desired to consider the saturations of the control inputs, thanks to the saturation function σ.

Hence, it is possible to rewrite our LPV system in the following form:

$$Δ \dot{\underline{x}} = A ( \underline{p} ) Δ \underline{x} + {B}_{w} ( \underline{p} ) Δ \underline{w} + {B}_{u} ( \underline{p} ) \underline{σ} Δ \underline{u} + {B}_{h} ( \underline{p} ) \underline{ϕ} ( Δ \underline{h} ) \qquad [ Math . 31 ]$$

$$Δ \underline{h} = {C}_{h} ( \underline{p} ) Δ \underline{x} + {D}_{hw} ( \underline{p} ) Δ \underline{w} + {D}_{hu} ( \underline{p} ) \underline{σ} Δ \underline{u} + {D}_{hh} ( \underline{p} ) \underline{ϕ} ( Δ \underline{h} )$$

$$\underline{z} = {C}_{z} Δ \underline{x}$$

$$\underline{y} = Δ \underline{x} .$$

In this equation, the vector z is expressed in the form: z=[x_{L} y_{L} Δψ]^{τ}. Hence, it consists of the position and yaw error vector.

As regards the saturation of the actuators of the vehicle, the following inequalities are considered:

$$30 deg \leq {δ}_{f} \leq 30 deg , and$$

$$5 , 000 Nm \leq {τ}_{wf} \leq 1 , 230 Nm .$$

These thresholds are herein substantially equal to the maximum capacities of the actuators.

As shown in FIG. 7, to impose on the closed loop a behaviour complying with these saturations, the filters Wₑ(s), Wᵤ(s) and W_{d}(s) are added to the system. Afterwards, the synthesis could be carried out using the augmented system Gₐ(s).

To carry out the synthesis, it should be noted that the filter W_{d}(s) is not used since the reference input is not used in the system. The filters Wₑ(s) et Wᵤ(s) are then enough to adjust the two input-output relationships between the disturbance signals Δw and the controlled outputs z₁ and z₂ (which measure the performance of the system, respectively in terms of setpoint tracking and path tracking).

The used filters Wₑ(s) and Wᵤ(s) are:

$${W}_{e} ( s ) = [ \begin{matrix}{W}_{e 11} ( s ) & 0 & 0 \\ 0 & {W}_{e 22} ( s ) & 0 \\ 0 & 0 & 1\end{matrix} ] \qquad [ Math . 32 ]$$

$${W}_{u} ( s ) = [ \begin{matrix}{W}_{u 11} ( s ) & 0 \\ 0 & {W}_{u 22} ( s )\end{matrix} ]$$

$${W}_{e 11} ( s ) = \frac{0.8333 e + 8.021}{s + 4.01}$$

$${W}_{e 22} ( s ) = \frac{0.8333 s + 8.317}{s + 3.176}$$

$${W}_{u 11} ( s ) = \frac{2 s + 3.848}{s + 11.54}$$

$${W}_{u 22} ( s ) = \frac{2 s + 23.09}{s + 69.26}$$

The desired corrector K (dynamic LPV) has the following form:

$${\dot{\underline{x}}}_{k} = {A}_{K} ( \underline{p} ) {\underline{x}}_{k} + {B}_{K} ( \underline{p} ) \underline{y} + {E}_{Ku} ( \underline{p} ) \underline{ϕ} ( Δ \underline{u} ) \qquad [ Math . 33 ]$$

$$Δ \underline{u} = {C}_{K} {\underline{x}}_{k} + {D}_{K} \underline{y}$$

In this equation, it should be observed that the corrector K is expressed in the form of the state representation xₖ.

The term EKu(p)·Φ(Δu) represents an “anti-windup” component for the saturation of the control signals. This term is negligible as long as no saturation appears but, on the other hand, takes on a non-zero and non-negligible value in case of saturation, which allows countering the drifts of errors due to this saturation phenomenon on the control inputs.

In other words, the proposed synthesis using an “anti-windup” component is a technique for tuning the corrector which allows explicitly taking account of the phenomena of saturation of the actuators and reducing their negative impact on the dynamics of a controlled system. The method proposed hereinafter is then based on the use of sector conditions in order to embed the saturation function. It exploits the Lyapunov stability through quadratic functions allowing expressing the stability and performance conditions by linear matrix inequalities (in English, Linear Matrix Inequalities LMI).

Thus, to synthesise the corrector K on this basis, the method is carried out based on convex optimisation criteria under linear matrix inequalities LMI constraints (the linearity of the terms of the used matrices guaranteeing that the mathematical problem could be solved without requiring an excessively huge computing load).

More specifically, the objective is to optimise the gains of the closed loop defined by the corrector K by acting on the choice of the poles.

The stability of the closed loop is computed while taking account of the sector non-linearities at the input of the system through the generalised sector condition.

For the synthesis of the corrector, the following constraints are considered:
the limitation of the performance H_{∞} of the input-output relationships between the disturbance signals Δw and the controlled outputs z₁ and z₂ of the closed loop, to maximise its robustness and the rejection of the disturbances,
the limitation of the performance H₂-generalised of the input-output relationship between the disturbance signals Δw and the outputs z₂ of the closed loop, to reduce the possibility of saturation of the control signals,
the placement of the poles of all of the LTI embodiments of the closed loop in the range of variation of the vector p in the region LMI denoted [symbol] , shown in FIG. 8 and whose values are:

$$\overline{λ} = - 1.5 ,$$

$$\underline{λ} = - 500 , and$$

$$θ = 0.6435 rad .$$

It is then possible to define this region as follows:

$$𝔻 = \{ z ∈ ℂ : L + zM + \overline{z} {M}^{T} \}$$

The used theorem, derived from the document by Scherer, Gahinet and Chilali 1997 and Tarbouriech et al. 2011, is as follows:

If there are matrices with the appropriate dimensions X (with the dimension n×n and such that X=X^{T}>0), Y (with the dimension n×n and such that Y=Y^{T}>0), Sᵤ (with the dimensions mᵤ×mᵤ, the diagonal being strictly positive), Jᵤ₁ (with the dimension mᵤxn), Jᵤ₂ (with the dimension mᵤ×n), Rᵤ (with the dimension n×mᵤ), Sₕ (with the dimensions pₕxpₕ, the diagonal being strictly positive), Jₕ₁ (with the dimension pₕxn), Jₕ₂ (with the dimension pₕxn), Â (with the dimension n×n), \hat{B} (with the dimension n×p_{y}), Ĉ (with the dimension mᵤxn), \hat{D} (with the dimension mᵤxp_{y}), a region [symbol] as mentioned before, and strictly positive scalars γ_{∞} and γ_{2g} such that the optimisation problem hereinbelow is feasible, a controller K that meets our objectives is therefore obtained.

The matrix inequations used herein are nine in number and are defined by the following inequations (for any i ranging from 1 to Ng, Ng being the number of points of the used grid).

$$He ( [ \begin{matrix}{A}_{i} X + {B}_{u i} \hat{C} & 0 & 0 & 0 \\ \dot{A} + {A}_{i}^{T} + {\dot{D}}^{T} {B}_{u i}^{T} & Y {A}_{i} + \dot{B} & 0 & 0 \\ {B}_{w i}^{T} + {D}_{yw}^{T} {\hat{D}}^{T} {B}_{u i}^{T} & {B}_{w i}^{T} {Y}^{T} + {D}_{yw}^{T} {\hat{B}}^{T} & - {γ}_{∞} I & 0 \\ {C}_{z} X + {D}_{zu} \hat{C} & {C}_{z} + {D}_{zu} \hat{D} & {D}_{z w} + {D}_{z u} \hat{D} {D}_{yw} & - {γ}_{∞} I\end{matrix} ] ) < 0 \qquad [ Math . 34 ]$$

$$He ( [ \begin{matrix}{A}_{i} X + {B}_{u i} \dot{C} & 0 & 0 \\ \hat{A} + {A}_{i}^{T} + {\hat{D}}^{T} {B}_{u i}^{T} & Y {A}_{i} + \hat{B} & 0 \\ {B}_{w i}^{T} + {D}_{y w}^{T} {\hat{D}}^{T} {B}_{u i}^{T} & {B}_{w i}^{T} {Y}^{T} + {D}_{y w}^{T} \hat{B} & - I\end{matrix} ] ) < 0$$

$$He ( [ \begin{matrix}X & 0 & 0 \\ I & Y & 0 \\ {C}_{{z}_{2}} X + {D}_{{z}_{3} u} \hat{C} & {C}_{{z}_{3}} + {D}_{{z}_{2} u} \hat{D} & {γ}_{2 g}^{2} I\end{matrix} ] ) < 0$$

$$L ⊗ [ \begin{matrix}X & I \\ I & Y\end{matrix} ] + M ⊗ [ \begin{matrix}{A}_{i} X + {B}_{u i} \hat{C} & {A}_{i} + {B}_{u i} \hat{D} \\ A & Y {A}_{i} + \ddot{B}\end{matrix} ] + {M}^{T} ⊗ {[ \begin{matrix}{A}_{i} X + {B}_{u i} \hat{C} & {A}_{i} + {B}_{u i} \hat{D} \\ \hat{A} & Y {A}_{i} + \ddot{B}\end{matrix} ]}^{T} < 0$$

$$[ \begin{matrix}X & I \\ I & Y\end{matrix} ] > 0$$

$$He ( [ \begin{matrix}{A}_{i} X + {B}_{u i} \hat{C} & 0 & 0 \\ \hat{A} + {A}_{i}^{T} + {\hat{D}}^{T} {B}_{u i}^{T} & Y {A}_{i} + \hat{B} & 0 \\ {S}_{u} {B}_{u i}^{T} - {J}_{u 1} & {R}_{u} - {J}_{u 2} & - 2 {S}_{u}\end{matrix} ] ) < 0$$

$$[ \begin{matrix}X & I & {\dot{C}}_{j}^{T} - {{J}_{u 1}^{}}_{j}^{T} \\ I & Y & {\hat{D}}_{j}^{T} - {{J}_{u 1}^{}}_{j}^{T} \\ {\hat{C}}_{j} - {J}_{u 1 j} & {\hat{D}}_{j} - {J}_{u 2 j} & {\overline{u}}_{j}^{2}\end{matrix} ] \geq 0 \qquad ∀ j = 1 … {m}_{u}$$

$$He ( [ \begin{matrix}{A}_{i} X + {B}_{u i} \hat{C} & 0 & 0 \\ \hat{A} + {A}_{i}^{T} + {\hat{D}}^{T} {B}_{u i}^{T} & Y {A}_{i} + \hat{B} & 0 \\ {S}_{h} {B}_{ϕ}^{T} - {C}_{h i} X - {D}_{hu i} \hat{C} - {J}_{h 1} & {S}_{h} {B}_{ϕ}^{T} Y - {C}_{h ϕ} - {D}_{h u i} \hat{D} - {J}_{h 2} & - ( I + {D}_{h ϕ} ) {S}_{h}\end{matrix} ] ) < 0$$

$$[ \begin{matrix}X & I & {{J}_{h 1}}_{k}^{T} \\ I & Y & {{J}_{h 2}}_{k}^{T} \\ {J}_{h 1 k} & {J}_{h 2 k} & {\overline{h}}_{k}^{2}\end{matrix} ] \geq 0 \qquad ∀ k = 1 … {p}_{h}$$

It should be noted that in these inequations:
Yⱼ and Jᵤⱼ are the rows of the matrices Y and Jᵤ (for any j ranging from 1 to mᵤ),
ūⱼ are the maximum values of the control inputs (Δδ̅_{f} and Δτ̅_{wf} therefore being the maximum values of Δδ_{f} and Δτ_{wf}),
Yₖ and Jₕₖ are the rows of the matrices Y and Jₕ (for any k ranging from 1 to pₕ),
h̅ₖ are the maximum values of the deviations of the friction forces of the tyres along the reference path, i.e. the maximum values of ΔF_{xf}, ΔFₓᵣ, ΔF_{yf} and ΔF_{yr}.

It will be observed that these nine inequations are respectively related to the following constraints.

The first of these inequations imposes a limit on the norm H_{∞} (between the transfers of the disturbance inputs towards the controlled outputs z₁ and z₂). This amounts to minimising the performance in the direction H_{∞} of the relationship between a disturbance and a position and/or yaw and/or control error.

The second and third inequations impose a limit on the norm H₂ (between the transfers of the disturbance inputs towards the controlled output z₂). This amounts to minimising performance in the direction H_{2 generalised} of the relationship between a disturbance and a control signal.

The fourth inequation allows placing the poles in the region LMI [symbol] of the complex plane.

The fifth inequation allows ensuring that there is a Lyapunov matrix that could be written in a suitable form.

The sixth and seventh inequations relate to generalised sector conditions for the saturation of the control inputs (that of the actuators).

The last two inequations relate to generalised sector conditions for the saturation of the friction forces exerted on the tyres.

Thus, if the aforementioned system of inequations is solved, then the dynamic corrector K can be calculated using the following matrices:

$${E}_{K u} ( \underline{p} ) = {N}^{- 1} ( {R}_{u} - Y {B}_{u} ( \underline{p} ) {S}_{u} ) {S}_{u}^{- 1} \qquad [ Math . 35 ]$$

$${D}_{K} = \hat{D}$$

$${C}_{K} = ( \hat{C} - {D}_{K} X ) {M}^{- T}$$

$${B}_{K} ( \underline{p} ) = {N}^{- 1} ( \hat{B} - Y {B}_{u} ( \underline{p} ) {D}_{K} )$$

$${A}_{K} ( \underline{p} ) = {N}^{- 1} ( \hat{A} - N {B}_{K} X - Y {B}_{u} ( \underline{p} ) {C}_{K} {M}^{T} - Y ( A ( \underline{p} ) + {B}_{u} ( \underline{p} ) {D}_{K} ) X ) {M}^{- T}$$

And then, this corrector K ensures:
the stability of the LPV system given by the equation Math31 where the ellipsoid ε(P, 1) is an Asymptotic Stability Region (or ASR) of the closed-loop system with saturated inputs,
that the poles of all embodiments in the sense LTI of the closed loop in the range of variation of the parameters are within the region [symbol] , and
that the performances H_{∞} and H_{2-generalised} of the closed loop are lower than the scalars γ_{∞} and γ_{2g}.

The matrix P of the quadratic Lyapunov function is such that:

$$P = [ \begin{matrix}Y & N \\ {N}^{T} & \hat{Y}\end{matrix} ] \qquad [ Math . 36 ]$$

$${P}^{- 1} = [ \begin{matrix}X & M \\ {M}^{T} & \hat{X}\end{matrix} ]$$

The conditions set out by the last two inequations of the system Math34 (for any j ranging from 1 to mᵤ and any k ranging from 1 to pₕ) consider that the saturation limits of the commands and the friction forces of the tyres are symmetrical with respect to zero.

In practice, in our case, these limits are not symmetrical. In order for them to become so, a conservative approach is used consisting in considering the lowest saturation threshold of the parameters Δδ_{f}, Δτ_{wf}, ΔF_{xf}, ΔFₓᵣ, ΔF_{yf} and ΔF_{yr} along the considered two reference paths.

Moreover, one could observe that the inequality SₕB^{τ}_{ϕ}Y appears in the condition given by the penultimate one of the inequations of the system Math34. Hence, the resulting optimisation problem that uses this constraint is not convex. In order not to have to solve a non-convex optimisation problem, there are two solutions.

The first solution consists in selecting a value for Sₕ a priori, which would therefore no longer be a decision variable. This solution turns out to be complicated to implement if one wishes to obtain reliable and non-conversative results.

The second solution consists in using the method proposed in the document by Garcia et al. 2009 and Silva et al. 2008, which requires adding an anti-windup component to the corrector K, also for the saturation of the forces of the tyres.

It should also be noted that estimating the friction forces of the tyres is a difficult task. Hence, a corrector that does not require measuring the expression ϕ(Δh) is desired. Then, to obtain a corrector without an “anti-windup” component for the friction forces of the tyres, it is possible to use the following procedure:
the second one of the aforementioned solutions is used in order to compute a corrector K with anti-windup for the expression ϕ(Δh), as set out hereinafter, then
the solution of the matrix Sₕ is recovered and used to solve an optimisation problem under the constraints of the inequations Math34.

In order to compute this corrector with anti-windup, the matrix inequations LMI are used herein again, but in a very simplified manner.

This time, the used theorem is as follows.

If there are matrices with appropriate dimensions X (with the dimension n×n and such that X=X^{τ}>0), Y (with the dimension n×n and such that Y=Y^{τ}>0), Sᵤ (with the dimensions mᵤ×mᵤ, the diagonal being strictly positive), Jᵤ₁ (with the dimension mᵤ×n), Jᵤ₂ (with the dimension mᵤ×n), Rᵤ (with the dimension n×mᵤ), Sₕ (with the dimensions pₕ×pₕ, the diagonal being strictly positive), Jₕ₁ (with the dimension pₕ×n), Jₕ₂ (with the dimension pₕ×n), Â (with the dimension n×n), \hat{B} (with the dimension n×p_{y}), Ĉ (with the dimension mᵤ×n), \hat{D} (with the dimension mᵤxp_{y}), a region [symbol] as mentioned before, and strictly positive scalars γ_{∞} and γ_{2g} such that all the inequations of the system Math 34 are valid (except for the penultimate one whose validity is not looked for) and that the following inequation is valid for all i ranging from 1 to N_{g}:

$$He ( [ \begin{matrix}{A}_{i} X + {B}_{u i} \dot{C} & 0 & 0 \\ \hat{A} + {A}_{i}^{T} + {\hat{D}}^{T} {B}_{u i}^{T} & Y {A}_{i} + \hat{B} & 0 \\ {S}_{h} {B}_{ϕ}^{T} - {C}_{h i} X - {D}_{h u i} \hat{C} - {J}_{h 1} & {R}_{h}^{T} - {C}_{h i} - {D}_{h u i} \hat{D} - {J}_{h 2} & - ( I + {D}_{h ϕ} ) {S}_{h}\end{matrix} ] ) < 0 \qquad [ Math . 37 ]$$

then, a solution of the dynamic corrector with an anti-windup component also for the friction forces of the tyres is found.

The solution of the matrix Sₕ thus found may be used to make the synthesis problem of the regulator without anti-windup convex.

When searching the corrector K, it is desired to maximise the region of attraction of the closed loop with respect to the saturations of the control inputs and the friction forces of the tyres. For this purpose, one search to minimise the trace of P, which could be done by minimising a strictly positive scalar ρ_{P} and by adding the constraint given by the inequation within the meaning of the following LMI:

$$[ \begin{matrix}{ρ I}_{P} & I & 0 \\ I & Y & I \\ 0 & I & X\end{matrix} ] \geq 0 \qquad [ Math . 38 ]$$

Finally, the following optimisation problem is solved:

$$\begin{matrix}{min}_{\{ {ρ}_{P} , X , Y , \hat{A} , \hat{B} , \hat{C} , \hat{D} , {J}_{u 1} , {J}_{u 2} , {R}_{u} {S}_{u} , {J}_{h 1} , {J}_{h 2} \}} & {ρ}_{P}\end{matrix} \qquad [ Math . 39 ]$$

while complying with the inequations Math34 and Math38.

Then, thanks to the equation Math33, it is possible to deduce the corrector K therefrom.

To solve this optimisation problem, we have used “toolbox YALMIP de MATLAB, cf. Lofberg 2004”, with “solver Mosek, cf. Andersen and Andersen 2000”. Of course, it would be possible to use other methods.

One could note the following two observations regarding the iteration of the solution described herein with other algorithms already currently present on a motor vehicle (typically the algorithm for keeping the vehicle at the centre of its traffic lane).

Firstly, as long as these other algorithms have higher dynamics than those of this control and that they are not actively involved in the yaw of the vehicle, there will be no stability problem related to the nested loops and a traction control (which smartly distributes the torque between the four wheels) could possibly contribute to the stability of the closed loop.

Secondly, the idea of the solution described herein consists in performing an avoidance and, as such, when this algorithm is activated, the other algorithms in presence that might have an influence on the path of the vehicle will be deactivated.

The computing assumptions being now properly established, it is possible to describe the method that will be executed by the computer 13 of the motor vehicle to implement the invention.

The computer 13 is herein programmed to implement this method recursively, i.e. step-by-step, and in loop.

For this purpose, during a first step, the computer 13 verifies that the autonomous obstacle avoidance function (AES) is activated and that an obstacle reference path has been planned.

The computer 13 will then search to define a control setpoint for the conventional steering system and for the conventional braking system, allowing following this reference path T0 as best as possible.

For this purpose, it begins by computing the parameters that make up the measurement vector y (Δv Δu Δr x_{L} y_{L} Δψ).

More specifically, knowing the nominal values x₀, y₀, ψ₀, v₀, u₀, r₀ of the parameters which theoretically enable the motor vehicle 10 to follow the reference path T0, and knowing the current values x, y, ψ, v, u, r of these same parameters while the vehicle follows the reference path T0 (i.e. the measured or estimated values of these parameters), the computer 13 can calculate the deviations Δv, Δu, Δr, xL, yL, Δψ between the current and nominal values of these parameters.

Then, considering the equation Math33, it is possible to use the corrector Kin order to determine the values of the pursued control instructions δ_{f}, τ_{wf}.

Finally, these steering angle and braking (or acceleration) setpoints will be transmitted to the actuators to steer and brake or accelerate the wheels of the motor vehicle 10.

This method is then repeated in loop, all along the reference path T0.

The present invention is in no way limited to the described and shown embodiment, but a person skilled in the art should know how to make any variant in accordance with the invention.

1. A method for autonomously controlling actuators of an automotive machine which are adapted to influence the path and the speed of said automotive machine, including steps of:
acquiring a reference path that said automotive machine should follow,
determining a nominal value of at least one parameter enabling the automotive machine to follow the reference path,
determining a current value of each parameter when said automotive machine follows the reference path,
determining a value deviation between the current value and the nominal value of each parameter, then
computing, with a computer, a control setpoint for each actuator, according to each value deviation, by means of a corrector, wherein the corrector allows jointly computing an exclusively lateral control setpoint of the automotive machine and an exclusively longitudinal control setpoint of the automotive machine.

2. The control method according to claim 1, wherein, said automotive machine being a vehicle which comprises at least one wheel adapted to be steered in a variable direction, at least one power steering actuator, at least one braking actuator and at least one propulsion actuator of the vehicle, the lateral control setpoint is transmitted to said at least one power steering actuator to steer said at least one wheel, and the longitudinal control setpoint is transmitted to said at least one braking actuator or to said at least one propulsion actuator to brake or accelerate the vehicle.

3. A method for developing a corrector for use thereof in a control method in accordance with claim 1, wherein it is provided to:
model the automotive machine in a non-linear form,
linearise said model in a linear parameter-varying form,
synthesise a corrector which ensures a reference path tracking, and wherein the corrector is synthesised by considering a finite number of points defined by distinct values of variable parameters.

4. The development method according to claim 3, wherein steps are provided for:
S1—acquiring a validation grid composed of several points,
S2—creating a first grid of points less dense than the validation grid,
S3—synthesising a first corrector with the first grid,
S4—determining whether the first corrector is valid over the entire validation grid, then:
if the first corrector is valid over the entire validation grid, the corrector is considered to be equal to the first corrector,
otherwise, another grid denser than the first grid is generated and then steps S3 and S4 are repeated with this other grid.

5. The development method according to claim 4, wherein the first grid includes, for a most of the variable parameters, only the maximum and minimum limits of variation of these variable parameters, said limits being determined for two extreme reference paths.

6. The development method according to claim 3, wherein the modelling of the automotive machine in a non-linear form is derived from equilibrium equations of the forces applied to the automotive machine.

7. The development method according to claim 6, wherein the forces applied to the automotive machine comprising normal reaction forces as well as longitudinal and lateral friction forces that the ground exerts on wheels of the automotive machine, to linearise said model in a linear parameter-varying form, a thresholding function applied to the normal reaction forces and to the longitudinal and lateral friction forces is used.

8. The development method according to claim 6, wherein, the model considering control inputs of the actuators, to linearise said model in a linear parameter-varying form, a saturation function applied to the control inputs is used.

9. The development method according to claim 3, wherein the variable parameters include the longitudinal acceleration of the automotive machine, its longitudinal speed, its lateral speed, its yaw rate, its heading angle and a steering angle.

10. The development method according to claim 3, wherein the corrector includes an “anti-windup”.

11. The development method according to claim 3, wherein the regulator is synthesised from convex optimisation criteria under linear matrix inequalities constraints, at least one of the constraints including:
minimising the performance in the direction H_{∞} of the relationship between a disturbance applied to the automotive machine and a position or yaw error of the automotive machined,
minimising the performance in the direction H_{2 generalised} of the relationship between a disturbance applied to the automotive machine and a control signal of the automotive machine,
taking account of the amplitude saturations of the actuators.

12. An automotive machine comprising at least one actuator which is adapted to influence the path of said machine, at least one actuator which is adapted to influence the speed of said machine and a computer for controlling said actuators, characterised in that the computer is programmed to implement a method according to claim 1.
